(19) United States
(12) Patent Application Publication
(10) Pub. No.: US 2023/0370251 A1
(43) Pub. Date: Nov. 16, 2023

(54) SECURE COMPUTATION SYSTEM, SECURE COMPUTATION APPARATUS, SECURE COMPUTATION METHOD, AND PROGRAM

(71) Applicant: NIPPON TELEGRAPH AND TELEPHONE CORPORATION, Tokyo (JP)

(72) Inventor: Dai IKARASHI, Musashino-shi, Tokyo (JP)

(73) Assignee: NIPPON TELEGRAPH AND TELEPHONE CORPORATION, Tokyo (JP)

(21) Appl. No.: 18/030,276

(22) PCT Filed: Oct. 16, 2020
(86) PCT No.: PCT/JP2020/039082

§ 371 Date: Apr. 5, 2023

(51) Int. Cl. H04L 9/08

(52) U.S. Cl. CPC H04L 9/085; H04L 9/0869

(57) ABSTRACT

A secure computation apparatus obtains a sequence ρ∘f obtained by rotating elements fₚ₋₁, . . . , f₀ of a sequence f by ρ elements by secure computation using share of random number ρ and share of the sequence f without obtaining the random number p and the sequence f, obtains the value b′ϵ{0, . . . , p−1} representing the position of the element cf_{b′} whose value is α among the elements cfₚ₋₁, . . . , cf₀ in the sequence ρ∘f, and obtains the share of the value b by secure computation using the share of the random number ρ and the value b′. Here, p is an integer of 2 or more, f is a sequence of p elements fₚ₋₁, . . . , f₀, a value of one element f_{b} among the elements fₚ₋₁, . . . , f₀ is α, a value of an element other than the element f_{b} is other than α, and β is a random integer.

### TECHNICAL FIELD

The present invention relates to a secure computation technique.

### BACKGROUND ART

In secure computation (for example, refer to NPL 1, 2, and the like), it may be necessary to share a numerical value representing a position of an element having a specific value in a sequence of a plurality of elements. For example, in secure computation, in order to shift the most significant bit (most significant bit: MSB) of a bit string to a specific position, it is necessary to share a numerical value representing a position of the most significant bit.

### CITATION LIST

### Non Patent Literature

[NPL 1] Takashi NISHIDE, Takuma AMADA, “Multiparty Computation for Floating Point Arithmetic with Less Communication over Small Fields”, IPSJ Journal, Vol. Vol. 60 No. 9, pp. 1433 to 1447 (2019).
[NPL 2] Randmets, J., “Programming Languages for Secure Multiparty Computation Application Development,” PhD thesis. University of Tartu (2017).

### SUMMARY OF INVENTION

### Problems to be Solved by the Invention

However, there is no known technique for obtaining a numerical share representing a position of an element having a specific value while the position of the element having the specific value in a sequence of a plurality elements is kept secret from the share of the sequence of the plurality of elements.

The present invention was made in view of these points, and an object of the present invention is to obtain a numerical share representing a position of an element having a specific value while keeping the position of the element having the specific value hidden from the share of a sequence of a plurality of elements.

### Means to Solve the Problems

The secure computation apparatus obtains the sequence ρ∘f obtained by rotating the elements fₚ₋₁, . . . , f₀ of the sequence f by ρ elements by secure computation using the share of the random number ρ and the share of the sequence f without obtaining the random number ρ and the sequence f, obtains the value b′ϵ{0, . . . , p−1} representing the position of the element cf_{b′} whose value is α among the elements cfₚ₋₁, . . . , cf₀ in the sequence ρ∘f, and obtains the share of the value b by secure computation using the share of the random number ρ and the value b′. Here, p is an integer of 2 or more, f is a sequence of p elements fₚ₋₁, . . . , f₀, a value of one element f_{b} among the elements fₚ₋₁, . . . , f₀ is α, a value of an element other than the element f_{b} is other than α, a value representing a position of the element f_{b} is bϵ{0, . . . , p−1}, and ρ is a random number represented by an integer. Here, since ρ is a random number, ρ∘f is a randomized position of the element f_{b} and information b of the position of the element f_{b} cannot be obtained from ρ∘f.

### Effects of the Invention

Thus, in a secure computation apparatus of the present invention, from the share of a sequence of a plurality of elements, it is possible to obtain the share of a numerical value representing a position of an element having a specific value while keeping the position of the element having the specific value concealed in the sequence of the plurality of elements.

### BRIEF DESCRIPTION OF DRAWINGS

FIG. 1 is a conceptual diagram illustrating a configuration of a secure computation system of an embodiment.

FIG. 2 is a block diagram illustrating a functional configuration of the secure computation apparatus of the embodiment.

FIG. 3 is a flowchart for exemplifying a secure computation method of the embodiment.

FIG. 4 is a flowchart for explaining a specific example of a process of Step S13-j.

FIG. 5 is a block diagram for exemplifying a hardware configuration of the secure computation apparatus of the embodiment.

### DESCRIPTION OF EMBODIMENTS

An embodiment of the present invention will be described below with reference to the drawings.

### [Principle]

First, a principle of an embodiment will be described. In the embodiment, n secure computation apparatuses PA(0), . . . , PA(n−1) perform secure computation and each obtains a share of a numerical value representing a position of an element f_{b} having a specific value a from a share (secret sharing value) of a sequence f of a plurality of (p) elements fₚ₋₁, . . . , f₀ while keeping the position of the element f_{b} having the specific value a concealed among the sequences f of the plurality of elements fₚ₋₁, . . . , f₀. Here, n is an integer of 2 or more, j=0, . . . , n−1, and p is an integer of 2 or more. For example, p is a prime number (for example, p is a Mersenne prime number such as 61). Furthermore, f is a sequence of p elements fₚ₋₁, . . . , f₀, a value of one element f_{b} among the elements fₚ₋₁, . . . , f₀ is α, a value of an element other than the element f_{b} is other than α, and a value representing the position of the element f_{b} is bϵ{0, . . . , P−1}. Preferably, all the values of the elements other than the element f_{b} among the elements fₚ₋₁, . . . , f₀ are β, and β≠α. That is to say, preferably, each element fᵢ (where iϵ{0, . . . , p−1}) is binary (fiϵ{α, β}). For example, the sequence f is a bit string, each element fᵢ of the elements fₚ₋₁, . . . , f₀ is a bit, and the value of each element fᵢ of the elements fₚ₋₁, . . . , f₀ is 0 or 1. It may be (α, β))=(1,0) or (α, β)=(0,1). For example, the sequence f=(fₚ₋₁, . . . , f₀) represents a position b of a specific bit (for example, most significant bit) when an element AϵZ_{P} (that is, if A is regarded as an integer, A mod P) of a quotient ring Zₚ modulo P represented by p bits is expressed in binary and the value of the element f_{b} corresponding to the position b of the specific bit of the element A is α=1, and the value of the other elements is β=0. For example, p represents the number of bits of P. P is an integer of 1 or more, for example, P is a Mersenne number. An example of P is the Mersenne prime P=2p−1 (for example, 261-1). However, these do not limit the invention.

Each secure computation apparatus PA(j) holds p as a parameter. The share sha(f)ⱼ of the sequence f=(fₚ₋₁, . . . , f₀) of the p elements fₚ₋₁, . . . , f₀ is input to each secure computation apparatus PA(j). For example, the share sha(f)ⱼ of f=(fₚ₋₁, . . . , f₀) is a sequence of shares sha(fₚ₋₁)j, . . . , sha(f₀)ⱼ of each element fₚ₋₁, . . . , f₀. However, this does not limit the invention. The share sha(χ)ⱼ of χ represents the share assigned to the secure computation apparatus PA(j) among the shares (secret sharing value) obtained by secret sharing X according to a predetermined secret sharing method. There is no limit to the secret sharing method. Examples of the secret sharing method include (k, n)-secret sharing methods such as (k, n)-replica secret sharing methods (for example, refer to Reference Literature 1) and (k, n)-Shamir secret sharing methods (for example, refer to Reference Literature 2) and (k, k)-additive secret sharing methods. Here, k is an integer of 2 or more and n or less. A (k, n)-duplicate secret sharing method in the case of n=k is called a (k, k)-additive secret sharing method. Furthermore, the share of χ is expressed as sha(χ)ⱼ regardless of the type of secret sharing method. For example, the share sha(χ₁)ⱼ of χ₁ and the share (χ₂)ⱼ of χ₂ may be based on the same secret sharing method or may be based on different secret sharing methods.
Reference Literature 1: Dai IGARASHI, Hiroki HAMADA, Ryo KIKUCHI, Koji CHIDA, “Improvement of Secure computation Radix Sort Aiming at Statistical Processing of Internet Environment Response 1 Second”, SCIS2014, 2014.
Reference Literature 2: A. Shamir, “How to share a secret,” Communications of the ACM, Vol. 22, No. 11, pp. 612 to 613, 1979.

### <Step S1>

Each secret calculator PA(j) generates a share sha(ρ)ⱼ of a random number ρ represented by an integer. Preferably, the random number ρ is a uniform random number, but the random number ρ does not have to be a uniform random number. For example, a pseudo-random number which can be approximated to a uniform random number may be a random number p. Furthermore, the random number ρ may or may not be limited to an integer of 0 or more. Each secure computation apparatus PA(j) generates the share sha(ρ)ⱼ without obtaining the value of the random number ρ itself. For example, at least a part of n secure computation apparatuses PA(0), . . . PA(n−1) cooperate to generate the share sha(ρ)₀, . . . , sha(ρ)ₙ₋₁ of the random number ρ. The share of the random number ρ sha(ρ)₀, . . . , sha(ρ)ₙ₋₁ is, for example, a share obtained by secretly sharing the element ρϵZₚ (that is, if ρ is regarded as an integer, ρ mod p) of the quotient ring Zₚ modulo p. There is no limitation on the method of generating the shares sha(ρ)₀, . . . , Sha(ρ)ₙ₋₁. For example, each secure computation apparatus PA(j) of the k secure computation apparatuses PA(0), . . . , PA(k−1) may generate a random number ρⱼ and each random number ρⱼ may be sha(ρ)ⱼ when the share sha(ρ)ⱼ is based on the (k, k)-additive secret sharing method. In this case, ρ=ρ₀+ . . . +ρₖ₋₁ϵZₚ (that is, if ρ, ρ₀, . . . , ρₙ₋₁ are regarded as integers, ρ=ρ₀+ . . . +ρₖ₋₁ mod p) is satisfied. For example, each secure computation apparatus PA(j) of n secure computation apparatuses PA(0), . . . , PA(n−1) may generate random numbers ρⱼ and a true subset (set of sub-shares) of random numbers ρ₀, . . . , ρₙ₋₁ may be each share sha(ρ)ⱼ when the share sha(ρ)ⱼ conforms to the (k, n)-replica type secret sharing method. In the case of (K, n)-duplicate secret sharing method, ρ=ρ₀+ . . . +ρₙ₋₁ϵZₚ is satisfied and all of random numbers μ₀, . . . , ρₙ₋₁ can be obtained using any k shares of the shares sha(ρ)₀, . . . , sha(ρ)ₙ₋₁. but no information on p can be obtained from shares less than k.

### <Step S2>

Each secure computation apparatus PA(j) obtains a sequence ρ∘f=(cfₚ₋₁, . . . , cf₀) in which the elements fₚ₋₁, . . . , f₀ of the sequence f are rotated (circularly shifted) by ρ elements by secure computation using the share sha(ρ)ⱼ of the random number ρ and the share sha(f)ⱼ of the sequence without obtaining the random number ρ and the sequence f. For example, each secure computation apparatus PA(j) obtains a sequence ρ∘f which is a bit string obtained by bit-rotating the elements fₚ₋₁, . . . , f₀ of the sequence f which is a bit string by p bits. Since rotation is a sub-group of permutations, this process can be achieved, for example, by limiting the permutations to rotations by random permutations by secure computation (for example, Reference Literature 3). In addition, since rotation is equivalent to multiplication or division on the quotient ring, it can also be realized by exponentiation, multiplication, division, or the like by secure computation. In this case, the quotient ring method is a Mersenne prime.
Reference Literature 3: Hiroki HAMADA, Dai IGARASHI, Koji CHIDA, Katsumi TAKAHASHI, “Random Permutation Protocol for Three-Party Concealed Function Computation”, CSS2010 (2010).

The rotation of χ by ρ elements may cyclically shift χ to the left by ρ elements when p is positive, and cyclically shift χ to the right by ρ elements when ρ is negative. On the other hand, when ρ is positive, χ may be cyclically shifted to the right by ρ elements, and when ρ is negative, χ may be cyclically shifted to the left by ρ elements. Here, the sequence ρ∘f is a restored value (public value), but each secure computation apparatus PA(j) does not know the random number ρ itself. Therefore, although it is possible to ascertain the position of the element cf_{b}, (where b′ϵ{0, . . . , p−1}) whose value is α from the sequence ρ∘f=(cfₚ₋₁, . . . , cf₀), each secure computation apparatus PA(j) cannot ascertain which of the elements fₚ₋₁, . . . , f₀ in the original sequence f has the value of a (it is not possible to ascertain what number the element with the value of a was). Particularly, when the value of one element f_{b} among the elements fₚ₋₁, . . . , f₀ is α, and the values of all the elements other than the element f_{b} are β (β≠α), the information obtained from the sequence ρ∘f is indistinguishable from the information obtained from any random number. Therefore, higher safety can be ensured.

### <Step S3>

Each secure computation apparatus PA (j) obtains a value b′ϵ{0, . . . , p−1} representing the position of the element cf_{b′} in which the value is α among the elements cfₚ₋₁, . . . , cf₀ in sequence ρ∘f. That is to say, each secure computation apparatus PA(j) obtains a value b′ which satisfies cf_{b′}=α among the elements cfₚ₋₁, . . . , cf₀. b′, b, and ρ satisfy the relationship of b′=b+ρϵZₚ.

### <Step S4>

Each secret calculator PA(j) obtains the share sha(b)ⱼ of the value b using the share sha(ρ)ⱼ of the random number ρ and the value b′ on the basis of the relationship of b′=b+ρϵZₚ by secure computation. For example, when the share sha(ρ)ⱼ and the share sha(b)ⱼ are based on the (k, k)-additive secret sharing method or the (k, n)-replica secret sharing method, each secure computation apparatus PA(j) obtains sha(b)ⱼ=b′−sha(ρ)ⱼϵZₚ as the share sha(b)ⱼ of the value b.

### First Embodiment

Next, a first embodiment of the present invention will be described below with reference to the drawings. The following example will be described in the first embodiment.
P is a prime number. For example, P is a Mersenne prime number (for example, P=2⁶¹−1).
p is the number of bits of P. When P is a Mersenne prime number, p is also a prime number (for example, p=61).
The sequence f is a bit string of length p (p-dimensional vector (fₚ₋₁, . . . , f₀)) having 0 or 1 bits in each element fₚ₋₁, . . . , f₀.
The value of one element f_{b} among the elements fₚ₋₁, . . . , f₀ is α=1 and the values of all the elements other than the element f_{b} are β=0.

For example, the sequence f=(fₚ₋₁, . . . , f₀) represents the position of the most significant bit of AϵZ_{P} represented by the p bit and the value of the element f_{b} corresponding to the position b of the most significant bit is α=1 and the value of the other elements is β=0. Furthermore, in the embodiment, the share obtained by secret-sharing xϵZ_{y} (x mod y when x is regarded as an integer) according to the (k, n)-secret sharing method is expressed as [x]^{y}, the share obtained by secret-sharing xϵZ_{y} according to the (k, k)-additive secret-sharing method is expressed as <x>^{y}, and the share obtained by secret-sharing xϵZ_{y} according to the (k, n)-duplicate secret-sharing method is expressed as <<x>>y. Furthermore, [x]^{y} assigned to the secure computation apparatus PA(j) is expressed as [x]ⱼ^{y}, <x>^{y} assigned to the secure computation apparatus PA(j) is expressed as <x>ⱼ^{y}, and <<x>>^{y} assigned to the secure computation apparatus PA(j) is expressed as <<x>>ⱼ^{y}.

### <Configuration>

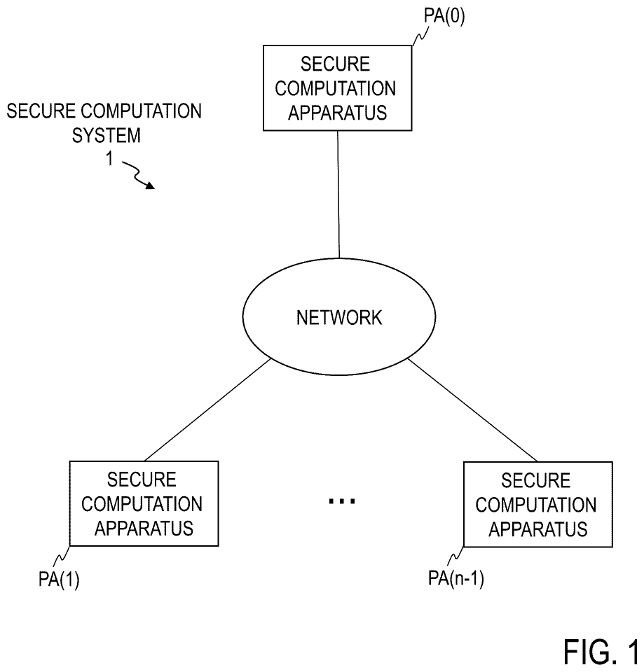

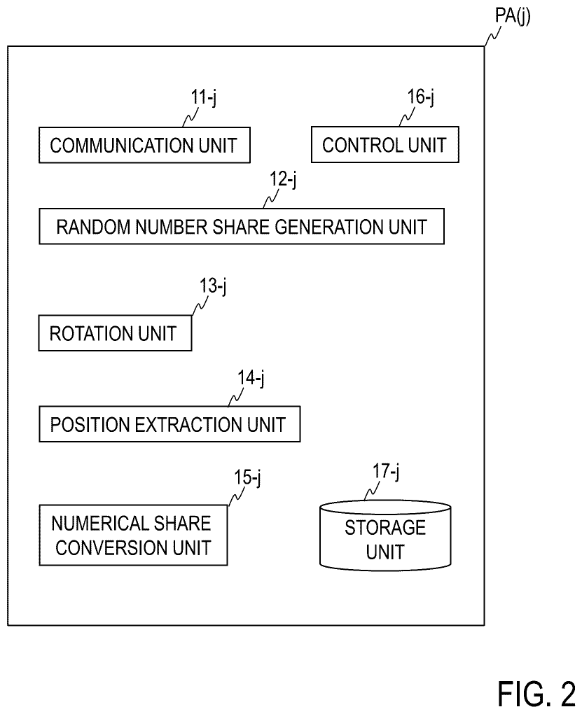

As illustrated in FIG. 1, a secure computation system 1 of the embodiment has n secure computation apparatuses PA(0), . . . , PA(n−1). The secure computation apparatuses PA(O), . . . , PA(n−1) are configured so that data can be exchanged. In this embodiment, the secure computation apparatuses PA(0), . . . , PA(n−1) are configured to be capable of communication via a network and an example of exchanging data via a network will be described. However, this does not limit the present invention and the secure computation apparatuses PA(0), . . . , PA(n−1) may be configured so that data can be exchanged via a portable recording medium and data may be exchanged via a portable recording medium. As illustrated in FIG. 2, the secure computation apparatus PA(j) of the embodiment has a communication unit 11-j, a random number share generation unit 12-j, a rotation unit 13-j, a position extraction unit 14-j, a numerical share conversion unit 15-j, a control unit 16-j, and a storage unit 17-j. The secure computation apparatus PA(j) performs each process under the control of the control unit 16-j. The data used in each process and the data obtained in each process are stored in the storage unit 17-j, read out as necessary, and used in each process. The bit number p of P is stored as a parameter in the storage unit 17-j. Furthermore, data is exchanged between the secure computation apparatuses PA(0), . . . , PA(n−1) through each communication unit 11-j.

### <Process>

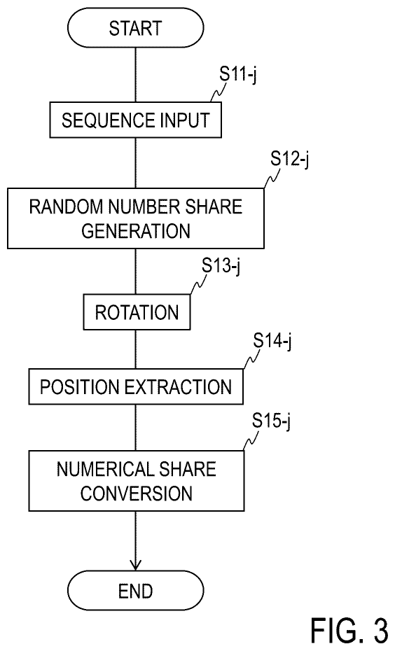

A process of each secure computation apparatus PA(j) will be described below with reference to FIG. 3. The bit share vector [f]ⱼ², which is the share of the sequence f=(fₚ₋₁, . . . , f₀), is input to the communication unit 11-j. The bit share vector [f]ⱼ² is, for example, a sequence of shares [fₚ₋₁]ⱼ², . . . , [f₀]ⱼ² of each element fₚ₋₁, . . . , f₀ (step S11-j).

The random number share generation unit 12-j uses p read from the storage unit 17-j and generates and outputs a share <<ρ>>ⱼ^{p} of a random number (for example, a uniform random number) p in cooperation with at least a part of the random number share generator 12-m of another secure computation apparatus PAₘ(where mϵ{0, . . . , n−1} and m≠j) (step S12-j).

The rotation unit 13-j obtains and outputs the sequence ρ∘f=(cfₚ₋₁, . . . , cf₀) obtained by rotating the elements fₚ₋₁, . . . , f₀ of the sequence f by ρ elements (bit rotation by p bits) by secure computation using the bit share vector [f]ⱼ² input in Step S11-j and the share <<ρ>>ⱼ^{p} of the random number ρ obtained in Step S12-j without obtaining the random number ρ and the sequence f. For example, the sequence ρ∘f when ρ is positive is the sequence f cyclically shifted to the left by the ρ element, and when ρ is negative, the sequence ρ∘f is the sequence f cyclically shifted to the right by the ρ element. A specific example of this process will be described later (Step S13-j).

The position extraction unit 14-j uses the sequence ρ∘f=(cfₚ₋₁, . . . , cf₀) obtained in Step S13-j and obtains and outputs a value b′ϵ{0, . . . , P−1} representing the position of the element cf_{b}, whose value is α=1 (Step S14-j) among the elements cfₚ₋₁, . . . , cf₀ in sequence ρ∘f.

The numerical share conversion unit 15-j calculates <<p>>ⱼ^{P}=b′−<<ρ>>ⱼ^{p}ϵZₚ by secure computation using the p read from the storage unit 17-j, the share of random number ρ obtained in Step S12-j<<ρ>>ⱼ^{p}, and the value b′ obtained in Step S14-j and outputs the obtained share <<p>>ⱼ^{p} (Step S15-j).

### Specific Example of Process of Step S13-j

The process of Step S13-j can be realized by using random permutation by secure computation (for example, refer to Reference Literature 3). A specific example of this process is shown below.

### Specific Example 1

Specific example 1 is an example in the case of n=3 and k=2.

1: The rotation unit 13-0 of the secure computation apparatus PA(0) and the rotation unit 13-1 of the secure computation apparatus PA(1) cooperate with each other and the bit share vector [f]₀² and the bit share vector [f]₁² are converted into the share <f>₀² and the share <f>₁² according to the (2,2)-additive secret sharing method (for example, refer to Reference Literature 4 and the like). That is to say, f=<f>₀²+<f>₁² is satisfied. The share <f>₀² is assigned to the secure computation apparatus PA(0), and the share <f>₁² is assigned to the secure computation apparatus PA(1).
Reference Literature 4: Kikuchi, R., Ikarashi, D., Matsuda, T., Hamada, K. and Chida, K., “Efficient Bit-Decomposition and Modulus-Conversion Protocols with an Honest Majority,” Information Security and Privacy-23rd Australasian Conference, ACISP 2018, Wollongong, NSW, Australia, Jul. 11-13, 2018, Proceedings (Susilo, W. and Yang, G., eds.), Lecture Notes in Computer Science, Vol. 10946, Springer, pp. 64-82 (online), DOI: 10.1007/978-3-319-93638-3 5 (2018).

2: The rotation unit 13-0 of the secure computation apparatus PA(0) and the rotation unit 13-1 of the secure computation apparatus PA(1) shares the sequence r₀₁=(r_{01, p-1}, . . . , r_{01, 0}) of the random number elements r_{01, p-1}, . . . , r_{01, 0}. For example, the rotation unit 13-0 may randomly generate the sequence r₀₁ and send it to the rotation unit 13-1, the rotation units 13-0 and 13-1 may share the seed value in advance, and may share the same sequence r₀₁ by a predetermined process using the seed value.

3: The rotation unit 13-0 of the secure computation apparatus PA(0) calculates B₀=(ρ₀₁)∘<f>₀²−r₀₁ using the share <<ρ>>₀^{P}, the share <f>₀², and the sequence r₀₁ and transmit it to the rotation unit 13-2 of the secure computation apparatus PA₂.

Here, the following relationship is satisfied.

<<ρ>>₀^{p}=(ρ₀₁,ρ₂₀)

<<ρ>>₁^{p}=(ρ₀₁,ρ₁₂)

<<ρ>>₂^{p}=(ρ₁₂,ρ₂₀)

ρ=ρ₀₁+ρ₁₂+ρ₂₀ϵZₚ

ρ, ρ₀₁, ρ₂₀, and ρ₁₂ are the elements of the quotient ring modulo p and the operation of ρ, β₀₁, ρ₂₀, and ρ₁₂, and the operation of the share of ρ, ρ₀₁, ρ₂₀, and ρ₁₂ are operations on the quotient ring Zₚ modulo p (operation on mod p).

4: The rotation unit 13-1 of the secure computation apparatus PA (1) calculates B₁=(ρ₀₁)∘<f>₁²+r₀₁ using the share <<ρ>>₁^{p}, the share <f>₁², and the sequence r₀₁ and transmits it to the rotation unit 13-2 of the secure computation apparatus PA₂.

5: The rotation unit 13-2 of the secure computation apparatus PA₂ calculates C=(ρ₂₀)∘((ρ₁₂)∘(B₀+B₁)) using the share <<ρ>>₂^{p}, the share <f>₂², B₀, and B₁. Here, the following holds.

C=(ρ₂₀)∘((ρ₁₂)∘(B₀+B₁))

=(ρ₂₀)ρ((ρ₁₂)∘((ρ₀₁)∘<f>₀²−r₀₁+(ρ₀₁)∘<f>₁²+r₀₁))

=(ρ₂₀)∘((ρ₁₂)∘((ρ₀₁)∘(<f>₀²+<f>₁²))

=(ρ₂₀)∘((ρ₁₂)∘((ρ₀₁)∘f)

=(ρ₂₀+ρ₁₂+ρ₀₁)∘f

=P∘f

### Specific Example 2

Specific Example 2 is an example in which n and k are generalized. In Specific Example 2, the set of n secure computation apparatuses PA(0), . . . , PA(n−1) is expressed as PA and the set of k secure computation apparatuses PA(φ(i, 0)), . . . , PA(φ(i, k−1)) selected from PA is referred to as SP(i). Here, n and k are integers of 2 or more, n>k, N=ₙCₖ, and i=0, . . . , N−1. ₙCₖ represents the total number of combinations when selecting k different from each other from n different from each other. Furthermore, φ (α, β) is a function value of α and β, and satisfies {φ (i, 0), . . . , φ (i, k−1)}∪{0, . . . , n−1}. SP(0), . . . , SP(N−1) are different from each other, and SP(0), . . . , SP(N−1) is configured as |SP(i′)∩SP(I′+1)^{c}|=1 about i′=0, . . . , N−2. Here, αc represents the complement of α, and |α| represents the number of elements of a. That is to say, the set SP(i′) is a set in which only one secure computation apparatus is different from the set SP(i′+1).

The share <f>_{(SP(i))} is k shares held by the set SP(i) according to the (k, k)-additive secret sharing method. In addition, particularly, the share <f>_{(SP(i))} is k shares <f>₀^{p}, . . . , <f>ₖ₋₁^{p} obtained by secret sharing f according to the (k, k)-additive secret sharing method. <f>_{(PA(θ)ϵSP(i))} is a share among the share <f>_{(SP(i))} held by the secure computation apparatus PA(θ)ϵSP(i).

The sub-share of n shares <<ρ>>₀^{p}, . . . , <<ρ>>ₙ₋₁^{p} obtained by secretly sharing ρ according to the (k, n)-duplicate secret sharing method is expressed as ρ₀, . . . , ρₙ₋₁ϵZₚ. That is to say, ρ=ρ₀+ . . . +ρₙ₋₁ϵZₚ (that is, ρ=ρ₀+ . . . +ρₙ₋₁ mod p) is satisfied. The sub-share of the sub-shares ρ₀, . . . , ρₙ₋₁ corresponding to the set SP(i) is expressed as ρ_{(SP(i))}. That is to say, ρ_{(SP(i))} represents a sub-share included in the share <<ρ>>_{(φ (i, 0))}^{p}, . . . , <<ρ>>_{(φ(i, k-1))}^{p} corresponding to k secure computation apparatuses PA(φ (i, 0)), . . . , PA(φ (i, k−1)) belonging to the set SP(i).

As described above, for i′=0, . . . , N−2, SP(0), . . . , SP(N−1) is configured so that |SP(i′)∩SP(i′+1)^{c}|=1 is satisfied. Here, PA(φ(i′, 0)) represents a secure computation apparatus included in the set SP (i′) and not included in the set SP(i′+1). Furthermore, PA(φ(i′+1, k)) represents a secure computation apparatus not included in the set SP(i′) but included in the set SP(i′+1). Furthermore, the PA(φ(i′, j)) for j=1, . . . , K−1 represents a secure computation apparatus included in both the set SP(i′) and the set SP(i′+1).

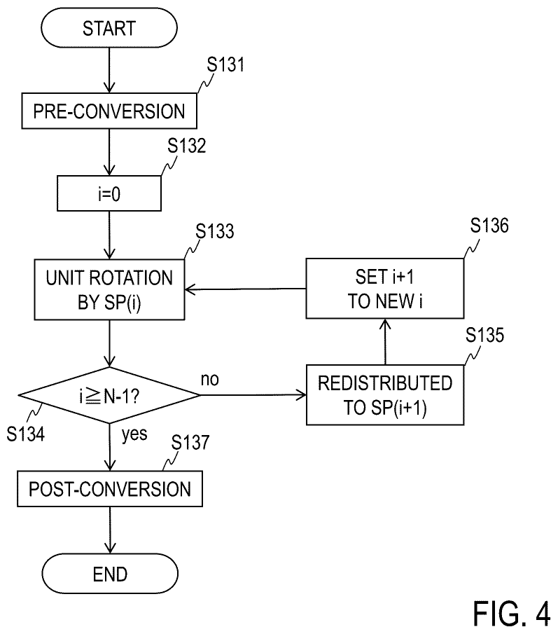

Specific Example 2 of Step S13-j will be described with reference to FIG. 4. Rotation units 13-φ(0,0), . . . , 12-φ((0, k−1)) of k secure computation apparatuses PA(φ(0,0)), . . . , PA(φ(0, k−1)) belonging to the set SP(0) convert bit share vectors [f]_{φ(0,0)}, . . . , [f]_{φ(0, k-1)}, which are the shares held by the set SP(0) into shares <f>₀, . . . , <f>ₖ₋₁ obtained by secretly sharing f (share <f>_{(SP(0))}) in accordance with the (k,k)-additive secret sharing method. The share <f>_{θ} is stored in a storage unit 17-0 of the secure computation apparatus PA(θ) (θϵ{φ(0, 0), . . . , φ(0, k−1)}) belonging to the set SP(0) (Step S131).

The control units 16-j of all the secure computation apparatuses PA(j) are set to i=0 (Step S132).

Rotational units 13-φ(i, 0), . . . , PA(φ(i, k−1)) of k secure computation apparatuses PA(φ(i, 0)), . . . , PA(φ(i, k−1)) belonging to the set SP(i) calculates (performs unit rotation on) ρ_{(SP(i))}∘<f>_{(SP(i))}ϵZₚ and stores a value obtained thereby as a new share <f>_{(SP(i))} in the storage unit 17-φ(i, 0), . . . , φ(i, k−1) (Step S133).

The control unit 16-j determines whether i≥N−1 is satisfied (Step S134). When i≥N−1 is satisfied, the process proceeds to Step S137, and when i≥N−1 is satisfied, the process proceeds to Step S135.

In Step S135, first, the rotation unit 13-φ(i, 0) of the secure computation apparatus PA(φ (i, 0)) and the rotation unit 13-φ(i, 1), . . . , 13-φ(i, k−1) of the secure computation apparatus PA(φ (i, 1)), . . . , PA(φ (i, k−1)) share random numbers r(i, 1), . . . , r(i, k−1))ϵZₚ. Furthermore, the rotation unit 13-φ(i, 0) of the secure computation unit PA(φ (i, 0)) uses a share <f>_{(PA(0)ϵSP(i))} and random numbers r(i, 1), . . . , r(i, k−1)) to obtain the share <f>_{(PA(k)ϵSP(i+1))}. That is to say, the secure computation apparatus PA(φ(i, 0)) obtains the share <f>_{(PA(k)ϵSP(i+1))} using the following Equation.

$${〈 f 〉}_{( P A ( k ) ∈ S P ( i + 1 ) )} = {〈 f 〉}_{( P A ( 0 ) ∈ S P ( i ) )} - {\sum }_{1 \leq {j}^{′} < k} r ( i , {j}^{′} )$$

The secure computation apparatus PA(φ(i, 0)) transmits the share <f>_{(PA(k)ϵSP(i+1))} obtained as described above to the secure computation apparatus PA(φ(i+1, k)). Furthermore, the rotation unit 13-φ(i, j′) of the secure computation apparatus PA(φ(i, j′)) obtains the share <f>_{(PA(j′)ϵSP(i+1))} using the share <f>_{(PA(j′)ϵSP(i))} and the random number r(i, j′) for j′=1, . . . , k−1. That is to say, each of the rotation units 13-φ(i, j′) of the secure computation apparatus PA(φ(i, j′)) has a share <f>_{(PA(j′)ϵSP(i+1))} using the following Equation (Step S135).

$${〈 f 〉}_{( PA ( {j}^{′} ) ∈ S P ( i + 1 ) )} = {〈 f 〉}_{( PA ( {j}^{′} ) ∈ S P ( i ) )} + r ( i , {j}^{′} )$$

The control unit 16-j of all the secure computation apparatuses PA(j) sets i+1 to a new i (Step S136) and the process proceeds to Step S133.

In Step S137 (when i≥N−1 is satisfied in Step S134), the rotation units 13-φ(N−1, 0), . . . , 13-φ(N−1, k−1) of the secure computation apparatus PA(φ(N−1, 0)), . . . , PA(φ(N−1, k−1)) belonging to the set SP(N−1) uses the share <f>_{(SP(N-1)} stored in the storage units 17-φ(N−1, 0), . . . , φ(N−1, k−1) in Step S133 and obtains the restored value ρ∘f in cooperation thereof.

### [Hardware Configuration]

The secure computation apparatus PA(j) in the embodiment is, for example, a device composed of a general-purpose or dedicated computer including a processor (hardware processor) such as a central processing unit (CPU) and a memory such as a random access memory (RAN) and a read only memory (ROM) and configured to execute a predetermined program. This computer may have one processor and one memory or may have a plurality of processors and a plurality of memories. This program may be installed in a computer or may be recorded in a ROM or the like in advance. Furthermore, a part or all of the processing units may be configured by using an electronic circuit which realizes a processing function independently, instead of an electronic circuit (circuitry) which realizes a function configuration by reading a program like a CPU. Furthermore, an electronic circuit constituting one device may include a plurality of CPUs.

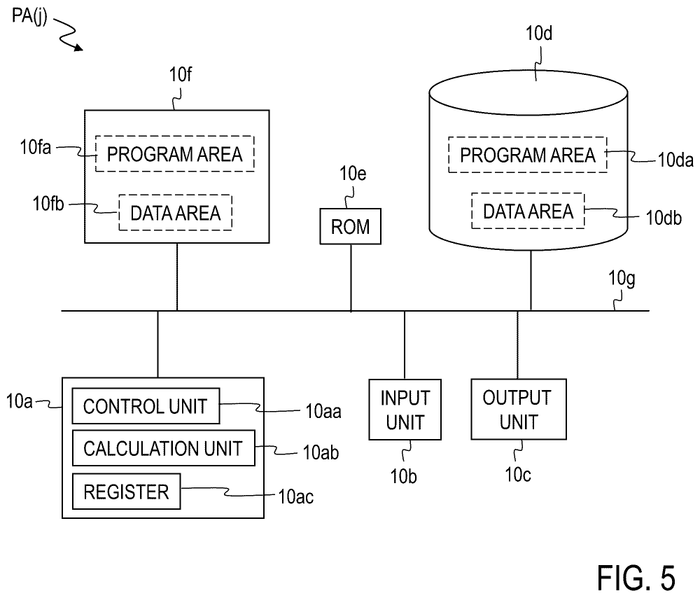

FIG. 5 is a block diagram illustrating a hardware configuration of the secure computation apparatus PA(j) in the embodiment. As illustrated in FIG. 5, the secure computation apparatus PA(j) of this example includes a central processing unit (CPU) 10a, an input unit 10b, an output unit 10c, a random access memory (RAN) 10d, a read only memory (ROM) 10e, an auxiliary storage device 10f, and a bus 10g. The CPU 10a of this example has a control unit 10aa, a calculation unit 10ab, and a register 10ac and executes various arithmetic processes in accordance with various programs read into the register 10ac. Furthermore, the input unit 10b is a communication device into which data is input, an input terminal, a keyboard, a mouse, a touch panel, or the like. Furthermore, the output unit 10c is a communication device from which data is output, an output terminal, a display, or the like. In addition, the RAM 10d is a static random access memory (SRAM), a dynamic random access memory (DRAM), or the like and has a program region 10da in which a predetermined program is stored and a data region 10db in which various data are stored. Moreover, the auxiliary storage device 10f is, for example, a hard disk, a magneto-optical (MO) disc, a semiconductor memory, or the like and has a program region 10fa in which a predetermined program is stored and a data region 10fb in which various data are stored. Furthermore, the bus 10g connects the CPU 10a, the input unit 10b, the output unit 10c, the RAM 10d, the ROM 10e, and the auxiliary storage device 10f so that information can be exchanged. The CPU 10a writes the program stored in the program region 10fa of the auxiliary storage device 10f to the program region 10da of the RAM 10d in accordance with the read operating system (OS) program.

Similarly, the CPU 10a writes various data stored in the data region 10fb of the auxiliary storage device 10f to the data region 10db of the RAM 10d. Also, the address on the RAM 10d in which this program or data is written is stored in the register 10ac of the CPU 10a. The control unit 10aa of the CPU 10a sequentially reads out these addresses stored in the register 10ac, reads a program or data from the region on the RAM 10d indicated by the read address, and reads the program or data, causes the calculation unit 10ab to sequentially execute the operations indicated by the program, and stores the calculation result in the register 10ac. With such a configuration, the functional configuration of the secure computation apparatus PA(j) is realized.

The above program can be recorded on a computer-readable recording medium. An example of a computer-readable recording medium is a non-transitory recording medium. Examples of such recording media are magnetic recording devices, optical discs, optomagnetic recording media, semiconductor memories, and the like.

The distribution of this program is performed, for example, by selling, transferring, renting, or the like a portable recording medium such as a DVD or a CD-ROM in which the program is recorded. Furthermore, the program may be stored in the storage device of the server computer and the program may be distributed by transferring the program from the server computer to another computer over a network. As described above, the computer which executes such a program first temporarily stores, for example, the program recorded on the portable recording medium or the program transferred from the server computer in its own storage device. Furthermore, when the process is performed, the computer reads the program stored in its own storage device and performs the process according to the read program. Furthermore, as another execution form of this program, a computer may read the program directly from a portable recording medium and execute processing according to the program and the processing according to the received program may be executed sequentially every time the program is transferred from the server computer to this computer. In addition, the above-mentioned process may be performed by a so-called application service provider (ASP) type service which realizes the processing function only by the execution instruction and result acquisition without transferring the program from the server computer to this computer. Note that the program in this embodiment includes information to be used for processing by a computer and equivalent to the program (data which is not a direct command to the computer but has a property that regulates the processing of the computer and the like).

Although the device is configured by executing a predetermined program on a computer in each embodiment, at least a part of these processing contents may be realized using hardware.

Note that the present invention is not limited to the above-described embodiment. For example, the various processes described above may not only be executed in chronological order according to the description, but may also be executed in parallel or individually as required by the processing capacity of the device that executes the processes. In addition, it goes without saying that changes can be made as appropriate without departing from the spirit of the present invention.

### INDUSTRIAL APPLICABILITY

The present invention can be used, for example, for secret calculations using shares. For example, in a secret calculation, in order to shift the most significant bit of a bit string to a specific position, it may be necessary to share a numerical value representing the position of the most significant bit. It is possible to obtain a numerical share which represents the position of the element with that particular value while keeping the position of the element having the specific value secret from the share of the column of the plurality of elements having the specific value in the element at the most significant bit position by using the present invention.

### REFERENCE SIGNS LIST

1 Secure computation system
PA(j) Secure computation apparatus
12-j Random number share generation unit
13-j Rotation unit
14-j Position extraction unit
15-j Numerical share conversion unit

1. A secure computation system in which n is an integer of 2 or more, j=0, . . . , n−1, p is an integer of 2 or more, f is a sequence of p elements fₚ₋₁, . . . , f₀, a value of one element f_{b} among elements fₚ₋₁, . . . , f₀ is α, a value of an element other than the element f_{b} is other than α, a value representing a position of the element f_{b} is be {0, . . . , p−1}, ρ is a random number represented by an integer, the system comprising:
n secure computation apparatuses PA(0), . . . , PA(n−1),
wherein the secure computation apparatus PA(j) includes processing circuitry configured to:
obtain a sequence ρ∘f by rotating the elements fₚ₋₁, . . . , f₀ of the sequence f by ρ elements by secure computation using a share of the random number ρ and a share of the sequence f without obtaining the random number ρ and the sequence f,
obtain a value b′E {0, . . . , p−1} representing a position of an element cf_{b′} whose value is α among the elements cfₚ₋₁, . . . , cf₀ in the sequence ρ∘f, and
obtain the share of the value b by secure computation using the share of the random number ρ and the value b′.

2. A secure computation apparatus in which p is an integer of 2 or more, f is a sequence of p elements fₚ₋₁, . . . , f₀, a value of one element f_{b} among elements fₚ₋₁, . . . , f₀ is α, a value of an element other than the element f_{b} is a value other than α, a value representing a position of the element f_{b} is be{0, . . . , p−1}, ρ is a random number represented by an integer, the secure computation apparatus comprising processing circuitry configured to:
obtain the sequence ρ∘f by rotating the elements fₚ₋₁, . . . , f₀ in the sequence f by ρ elements by secure computation using share of the random number ρ and share of the sequence f without obtaining the random number ρ and the sequence f,
obtain a value b′ϵ{0, . . . , p−1} representing a position of an element cf_{b′} in which the value is α among the elements cfₚ₋₁, . . . , Cf₀ in the sequence ρ∘f, and
obtain the share of the value b by secure computation using the share of the random number ρ and the value b′.

3. The secure computation apparatus according to claim 2, wherein
all values of the elements fₚ₋₁, . . . , f₀ other than the element f_{b} are β and β≠α is satisfied.

4. The secure computation apparatus according to claim 3, wherein
iϵ{0, . . . , p−1} is satisfied, a sequence f is a bit string, a value of each element fᵢ of the elements fₚ₋₁, . . . , f₀ is 0 or 1, (α, β)=(1,0) or (α, β)=(0,1) is satisfied, the random number ρ is an element of a quotient ring Zₚ modulo p, the share of the random number ρ is a share sha(ρ)ⱼ obtained by secretly sharing ρϵZₚ,
the processing circuitry obtains the sequence ρ∘f, which is a bit string obtained by bit-rotating the elements fₚ₋₁, . . . , f₀ in the sequence f by ρ bits,
the sha(ρ)ⱼ and the sha(b)ⱼ are shares obtained by secret sharing according to an additive secret sharing method or a duplicate secret sharing method, and
the processing circuitry obtains b′-sha(ρ)ⱼϵZₚ as the share sha(b)ⱼ of the value b.

5. The secure computation apparatus according to claim 2, wherein the random number ρ is a uniform random number.

6. A secure computation method, in which p is an integer of 2 or more, f is a sequence of p elements fₚ₋₁, . . . , f₀, a value of one element f_{b} among elements fₚ₋₁, . . . , f₀ is α, a value of an element other than the element f_{b} is a value other than α, a value representing a position of the element f_{b} is be {0, . . . , p−1}, ρ is a random number represented by an integer, the secure computation method comprising:
obtaining a sequence ρ∘f by rotating the elements fₚ₋₁, . . . , f₀ in the sequence f by ρ elements by secure computation using share of the random number ρ and share of the sequence f without obtaining the random number ρ and the sequence f;
obtaining a value be {0, . . . , p−1} representing a position of an element cf_{b′} whose value is α among the elements cfₚ₋₁, . . . , cf₀ in the sequence ρ∘f; and
obtaining the share of the value b by secure computation using the share of the random number ρ and the value b′.

7. A non-transitory computer-readable recording medium storing a program for operating a computer as the secure computation apparatus according to claim 2.
